(19) United States
(12) Patent Application Publication
(10) Pub. No.: US 2018/0270178 A1
(43) Pub. Date: Sep. 20, 2018

(54) METHOD AND APPARATUS FOR SHARING MATERIALS IN ACCORDANCE WITH A CONTEXT

(71) Applicant: AGT International GmbH, Zurich (CH)

(72) Inventors: Daniel CERNEA, Bensheim (DE); Michael LEIGSNERING, Muhltal (DE); Reffael CASPI, Tel Aviv (IL); Hagai LEVI, Ramat-Gan (IL)

(21) Appl. No.: 15/914,164

(22) Filed: Mar. 7, 2018

Related U.S. Application Data
(60) Provisional application No. 62/469,207, filed on Mar. 9, 2017.

(51) Int. Cl. H04L 12/58; G06K 9/00; G10L 25/63

(52) U.S. Cl. CPC H04L 51/20; G10L 25/63; G06K 9/00718; G06K 9/00335

(57) ABSTRACT

A computer-implemented method and a computer program product, the method comprising: receiving environmental sensory input from sensors embedded within a first device associated with the user, the environmental sensory input indicative of a user context; determining the context of the user from at least the environmental sensory input; receiving physiological sensory indicative of a user state input from physiological sensors embedded within a second device associated with the user; determining the state of the user from at least the physiological sensory input; determining a trigger based on at least the context and the state of the user; subject to the trigger, obtaining content materials based at least on the environmental sensory input, to be provided in association with the trigger; preparing message content to be sent in a message, using at least the content materials; and sending the message to at least one recipient over a digital communication channel.

### TECHNICAL FIELD

The presently disclosed subject matter relates to sharing materials in general, and to sharing materials in accordance with a context of a user, in particular.

### BACKGROUND

Currently used mobile devices such as smart phones are equipped with a variety of sensors which can be used for capturing a multiplicity of factors and content. The sensors may include sensors for taking or capturing physiological measures of a user of the device, actions performed by the user, and various environmental parameters. The sensors may also include capturing sensors such as one or more cameras, audio recorders or video recorders, for capturing images, audio and/or video of the user's environment. A plethora of other data may also be available to the device from various sensors or other data sources, such as the user's location, calendar, or others. Additionally, content may be available from any external source, for example over the internet. A user may want to share a selection of the captured or otherwise obtained data with other people, such as friends, family members, or the like.

U.S. Pat. No. 7,395,507 by Robarts et al. published on 2008, describes a system that filters received messages (e.g., unsolicited advertisements) to determine if they are appropriate for a user based on the non-static, constantly evolving, context of the user. The system can track the user's context by monitoring various environmental parameters, such as related to the user's physical, mental, computing and data environments, and can model the current context of the user based at least in part on the monitoring. The system selects a set of one or more filters to apply to incoming messages based on the user's context, and the selected filters can be updated as the user's context changes. Messages that survive the filters are then evaluated against the user's context to determine whether they should be presented immediately or stored for delayed presentation.

U.S. Pat. No. 9,380,413 by Joshi published on 2012 provides a system for dynamically forming the content of a message to a user, based on a perceived emotion state of the user. During operation, the system determines a geo-location of a user. Next, the system analyzes a news feed associated with the geo-location of the user to determine a perceived emotion state of the user. The system then forms a content for a message to the user based on the perceived emotional state of the user. Finally, the system delivers the message.

US 2001/0043232 by Abbott et al. published on 2001 discloses creating, modifying, categorizing, modeling, distributing, purchasing, selling, and otherwise using themes and theme-related information. Themes can represent various types of contextual aspects or situations, and can model high-level concepts of activities or states not reflected in individual contextual attributes that each model a single aspect of the state of a user, their computing device, the surrounding physical environment, and/or the current cyber-environment. Such themes specify inter-relationships among a set of contextual attributes, and can have associated theme-related information such as theme-specific attributes, theme layouts used to present information and functionality, context servers that provide theme attribute values, and context clients that process theme information. Disclosed techniques can identify one or more themes that currently match the modeled context, select one of the matching themes as a current theme, and provide an appropriate response (e.g., by presenting appropriate information and/or providing appropriate functionality) based on the current theme.

US 2010/0138416 by Bellotti published on 2010 provides a computing device that delivers personally-defined context-based content to a user. This computing device receives a set of contextual information with respect to the user, and processes the contextual information to determine a context which is associated with an activity being performed by the user. The computing device then determines whether either or both the context and a current activity of the user satisfy a trigger condition which has been previously defined by the user. If so, the computing device selects content from a content database, based on the context, to present to the user, and presents the selected content.

U.S. Pat. No. 8,682,302 by de Vries published on 2014 provides search and notifications to inform when certain people (e.g., friends, family, business contacts, etc.) are nearby so as to facilitate communications with those people. Users may define lists of people whose locations may be tracked by positioning equipment based on personal communications/computing devices carried by the people. The information service processes this people and place data to identify those of the listed people that are in the user's vicinity, and provide notifications and user-initiated search results informing the user such as via the user's personal communications/computing device.

US 2012/0209907 by Andrews published on 2012 provides a content aggregation and distribution service, which can execute in a cloud computing environment, provides content based on a broadcast user's topics of interest to a subscriber user based on the context of the subscriber. An example of a broadcast user is a celebrity. Content is automatically gathered about the broadcast user's designated topics of interest from online resources, and filtered and distributed based on a context of the subscriber. Some examples of online resources are websites, social networking sites, and purchase transaction systems. An example of broadcast content is a recommendation which may have been entered directly to the service or posted by the celebrity in his or her social networking account. Both the broadcast user and the subscriber can control respectively the distribution and reception of content with subscription settings. For examples, the settings may set limitations with respect to topics, contexts, and subscriber profile data.

### BRIEF SUMMARY

In accordance with one aspect of the disclosed subject matter there is provided a computer-implemented method for providing content associated with a user, comprising: receiving environmental sensory input from at least one sensor embedded within a first device associated with the user, the environmental sensory input indicative of a context of the user; determining the context of the user from at least the environmental sensory input; receiving physiological sensory input from at least one physiological sensor embedded within a second device associated with the user, the physiological sensory input indicative of a state of the user; determining the state of the user from at least the physiological sensory input; determining a trigger based on at least the context and the state of the user; subject to the trigger, obtaining content materials based at least on the environmental sensory input, to be provided in association with the trigger; preparing message content to be sent in a message, using at least the content materials; and sending the message to at least one recipient over a digital communication channel. Within the method, the second device is optionally the first device. Within the method, the message content is optionally prepared in accordance with a template associated with the context and the environmental sensory input. Within the method, the template is optionally selected from a multiplicity of templates in accordance with correspondence with the context and the state. Within the method, the environmental sensory input optionally comprises audio, video or at least one still image captured by the second device. Within the method, the context is optionally obtained from the environmental sensory input and from additional data. Within the method, at least part of the additional data is optionally selected from the group consisting of: a calendar of the user; social media associated with the user; and a location of the user. Within the method, the content materials optionally comprise output obtained by processing at least a portion of the environmental sensory input. Within the method, the content materials are optionally based also on the physiological sensory input or on the state. Within the method, the content materials optionally comprise data obtained from a source external to the user and the second device, or output of processing thereof. The method can further comprise sending the message to the user. The method can further comprise selecting one or more recipient groups comprising the at least one recipient associated with the user, and wherein the message is sent to the at least one recipient group. The method can further comprise clustering possible recipients into recipient groups, including the at least one recipient group. Within the method, the state of the user is optionally determined also in accordance with the context. Within the method, determining the trigger is optionally based on past sharing behavior of the user.

In accordance with another aspect of the disclosed subject matter there is provided a computer-implemented method for providing content to a recipient associated with a user, comprising: receiving physiological sensory input from at least one sensor embedded within a first device associated with the user, the physiological sensory input indicative of a state of the user; determining the state of the user from the physiological sensory input; receiving environmental sensory input from at least one sensor embedded within a second device associated with the user, the environmental sensory input indicative of a context of the user; determining the context of the user from at least the environmental sensory input; determining a trigger based on at least the context and the state of the user; selecting at least one recipient group comprising at least one recipient associated with the user, based at least on the context; and subject to the trigger, sending a message to the at least one recipient group over a digital communication channel. Within the method, the recipient group is optionally selected based upon the context and the state of the user. The method can further comprise generating a model upon which the at least one recipient group is selected. Within the method, the model is optionally generated by clustering possible recipients. Within the method, the model is optionally generated based at least on sharing behaviour of the user. Within the method, the model is optionally enhanced in accordance with user feedback.

In accordance with another aspect of the disclosed subject matter there is provided a computer program product comprising a computer readable storage medium retaining program instructions, which program instructions when read by a processor, cause the processor to perform a method comprising: receiving environmental sensory input from at least one sensor embedded within a first device associated with the user, the environmental sensory input indicative of a context of the user; determining the context of the user from at least the environmental sensory input; receiving physiological sensory input from at least one physiological sensor embedded within a second device associated with the user, the physiological sensory input indicative of a state of the user; determining the state of the user from at least the physiological sensory input; determining a trigger based on at least the context and the state of the user; subject to the trigger, obtaining content materials based at least on the environmental sensory input, to be provided in association with the trigger; preparing message content to be sent in a message, using at least the content materials; and sending the message to at least one recipient over a digital communication channel.

### BRIEF DESCRIPTION OF THE DRAWINGS

In order to understand the invention and to see how it can be carried out in practice, embodiments will be described, by way of non-limiting examples, with reference to the accompanying drawings, in which:

FIG. 1 illustrates a block diagram of a system for sharing content in accordance with a context, in accordance with certain embodiments of the presently disclosed subject matter;

FIG. 2 illustrates a flowchart of steps in a method for sharing content in accordance with a context, in accordance with certain embodiments of the presently disclosed subject matter;

FIG. 3 illustrates the main components in another system for sharing content in accordance with a context, in accordance with certain embodiments of the presently disclosed subject matter; and

FIG. 4 illustrates a block diagram of another embodiment of a system for sharing content in accordance with a context, in accordance with certain embodiments of the presently disclosed subject matter.

### DETAILED DESCRIPTION

In the following detailed description, numerous specific details are set forth in order to provide a thorough understanding of the invention. However, it will be understood by those skilled in the art that the presently disclosed subject matter may be practiced without these specific details. In other instances, well-known methods, procedures, components and circuits have not been described in detail so as not to obscure the presently disclosed subject matter.

Unless specifically stated otherwise, as apparent from the following discussions, it is appreciated that throughout the specification discussions utilizing terms such as “processing”, “computing”, “representing”, “comparing”, “generating”, “assessing”, “matching”, “updating” or the like, refer to the action(s) and/or process(es) of a computer that manipulate and/or transform data into other data, said data represented as physical, such as electronic, quantities and/or said data representing the physical objects. The term “computer” should be expansively construed to cover any kind of electronic device with data processing capabilities.

The operations in accordance with the teachings herein may be performed by a computer specially constructed for the desired purposes or by a general-purpose computer specially configured for the desired purpose by a computer program stored in a computer readable storage medium.

Embodiments of the presently disclosed subject matter are not described with reference to any particular programming language. It will be appreciated that a variety of programming languages may be used to implement the teachings of the presently disclosed subject matter as described herein.

The term “sensor” used in this patent specification should be expansively construed to cover any kind of a measuring or capturing device embedded within a device associated with a user, and capable of capturing an aspect of a user or the user's environment. Thus, one or more sensors may take physiological measures of the user such as temperature, heart rate, blood pressure, or the like. Yet one or more sensors may capture an aspect of the environment, such as temperature, location, or the like. Further one or more sensors may capture activity within the user's environment, such as images, audio or video; or the like. It will be appreciated that further types of sensors may be present and used within one or more mobile devices associated with a user.

The term “content” used in this patent specification should be expansively construed to cover any kind of data captured by a sensor, received from an external source for example by wired and/or wireless network communication, output of processing of one or more of the above, provided by a user or generated by a machine, or any combination thereof.

The term “context” used in this patent specification should be expansively construed to cover any kind of situation, location, event, happening, or another description of the user's situation. Some non-limiting examples of context include a concert or another show, a sports event, a party, a family gathering, a meeting, a medical situation, being at a location such as a mountain top, or any other situation a user may want to share with other people.

The term “state” used in this patent specification should be expansively construed to cover a user's physical or emotional state, as can be captured or derived from physiological measures, motions, analysis of one or more images or the user, analysis of the user's voice, or the like.

Mobile smart phones or other devices carried by users comprise a multiplicity of sensors capable of capturing the user's physiological measures and environment. Additionally, smart devices comprise sensors for capturing, creating or processing media content such as images, animations, infographics, audio recordings, video recordings, etc. The smart devices can also obtain any such material through one or more communication channels. All this data can describe the context the user is at, and can describe or provide an impression of his or her surroundings, activities, subjective state, or the like.

However, it is required that some of the sensory data or media content is arranged and presented in a coherent manner, in order to be shared at an appropriate time and in a predetermined manner with the user's friends, family, or any desired group of receivers. The appropriate time may be when the user is at a particular context and particular state. Thus, it is required to determine whether a message should be sent to recipients, and what content should be selected and possibly processed to be provided to the recipients, or whether such recipients exist.

For example, a situation may be considered in which the user is attending a concert, and is very excited to hear a particular song. The context, being attending a concert, may be determined from the captured environment and optionally additional data, for example the user's calendar, information indicating the time and place of the concert as crossed with the user's location at the time, or the like. The user's state may be assessed from the physiological measures. A trigger may be raised when the physiological sensors provide measures that indicate that the user assumes a particular stage, e.g., reacts strongly, for example one or more measures or a combination thereof may exceed a threshold. A message may then be assembled in accordance with the context, for example a message that combines live footage from the concert as captured by the user's mobile device, the song name and some representation of the user's reaction, e.g., “my excitement went through the roof”. This message may be automatically sent to a recipient group that may be selected from a multiplicity of groups, e.g., the user's friends who are fans of the playing band.

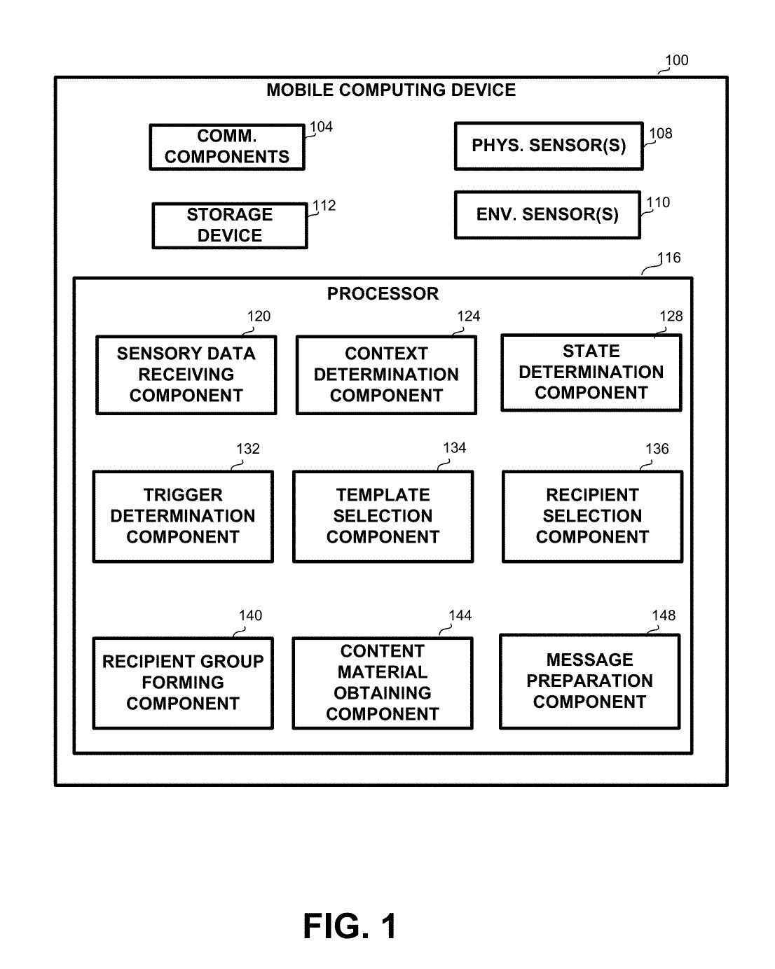

Referring now to FIG. 1, illustrating a block diagram of a system for sharing materials in accordance with user context and state, according to some embodiments of the disclosed subject matter.

A person, also referred to as a user, may carry or wear a mobile computing device 100, such as a smart phone, a tablet, a laptop, a personal digital assistant (PDA), a wearable computing device such as a smartwatch, or the like. The user may carry or wear more than one device. For example, the user may carry a smartphone, and wear a smartwatch, a bracelet, a wrist band, an arm band, a ring, or the like. If multiple devices are worn or carried by the user, the devices may communicate directly or indirectly with one another and are collectively referred to as mobile computing device 100.

Mobile computing device 100 may be equipped with one or more communication components 104, used for communication with other devices, servers, or the like, using any communication channel or protocol, such as GSM, Wi-Fi, Bluetooth, or the like.

Mobile computing device 100 may comprise one or more physiological sensors 108 providing physiological sensory input related to the user. Physiological sensors 108 may comprise sensors for measuring the user's temperature, pulse, blood pressure, or other physiological measures, using any contact or contact-free technology, including radar, ultrasound or others. Physiological sensors 108 may also comprise motion sensors, such as acceleration sensors, gyroscopes, or others, from which a motion of the user or body part thereof can be assessed.

Mobile computing device 100 may comprise one or more environmental sensors 110 providing environmental sensory input. Environmental sensors 110 may comprise one or more sensors for sensing parameters of the environment, such as temperature, humidity, location, or the like. Environmental sensors 110 may comprise one or more sensors for capturing aspects of the environment, such as a camera of any type, a voice recorder of any type, a video camera of any type, or the like.

Mobile computing device 100 may comprise storage device 112. Storage device may comprise any of the measures or content captured by any of physiological sensors 108 and/or environmental sensors 110, and optionally also content received from other sources, such as a user's calendar, web sites, another device, or the like.

Storage device 112 may also comprise data used for determining a state or a context of a user, such as topics or events a user is interested in, such that it may be identified that the user is at an event, a location of the like, which is important for him.

Storage device 112 may also comprise one or more templates indicating for various contexts and/or states which materials should be shared and in what manner. For example, in a concert, a recording may be selected of the song played before the user assumed a state upon which a message is sent, as well as information regarding the song. If the event is a trip, a few shots or video recordings taken along the day and until the last moments may be selected.

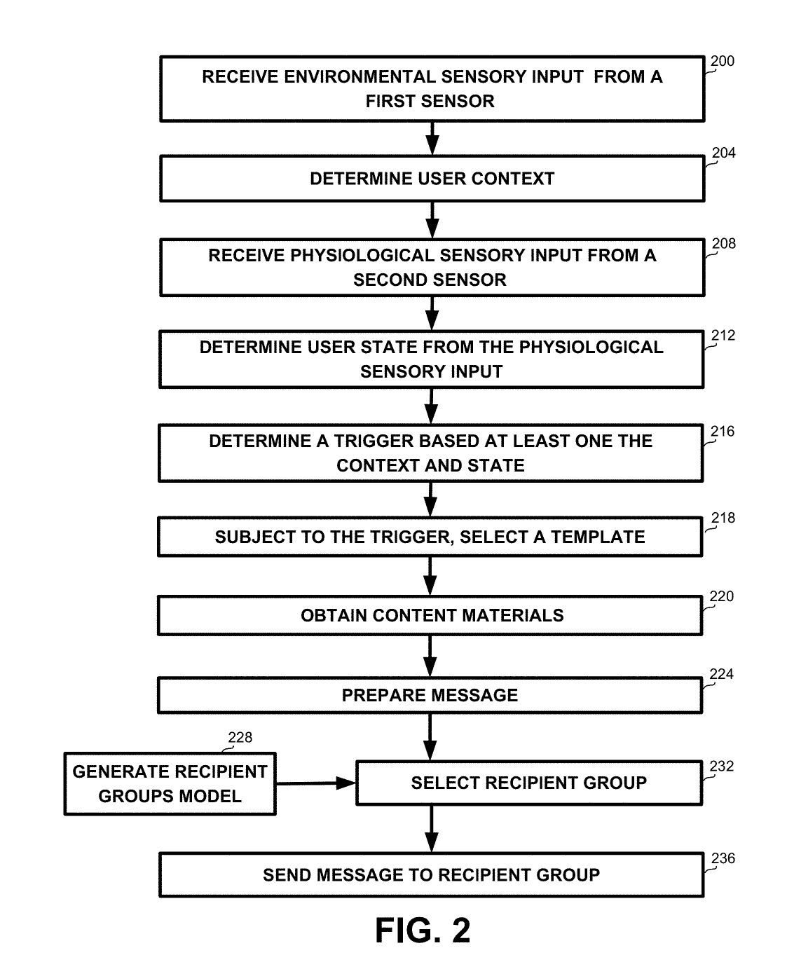

Mobile computing device 100 may comprise processor 116, such as a Central Processing Unit (CPU), a microprocessor, an electronic circuit, an Integrated Circuit (IC) or the like. Processor 116 may be configured to provide the required functionality, for example by loading to memory and activating one or more of the components detailed below, to perform the method disclosed in association with FIG. 2 below. In some embodiments, processor 116 can comprise two or more processors, collocated on the device or distributed. The components may be implemented as one or more collections of computer instructions, such as programs, dynamic or static libraries, executable modules, or the like, programmed in any programming language.

Processor 116 can comprise one or more sensory data receiving components 120, for receiving physiological sensory input from any of physiological sensors 108, or environmental sensory input from any of environmental sensors 110. The received input may be stored in storage device 112.

Processor 116 can comprise context determination component 124, for identifying whether the user is at a context complying with a situation stored in storage device 112 and invoking material sharing. For example, long stretches of loud music and applauds captured by a voice sensor may indicate that the user is at a concert, and then it may be checked whether a concert is one of the situations stored in storage device 112 and requiring the sharing of materials. A green field and voices indicating a sports match may indicate a football match, or the like. Context identification may also use data from the user's calendar, online data indicating an event taking place at the current time and location, or the like.

Processor 116 can comprise state determination component 128 for determining a state of the user. For example, a state may be determined based on a combination of one or more physiological measurements, for example blood pressure, temperature, motion amplitude or rate, or the like. In some embodiments, the state may be determined in accordance with the context, such that different contexts may imply different manners of combining the measures for determining the state, and hence different determined states. For example, since a user is not expected to wave his hands in a classical music concert, hand motion may be given a higher weight when determining the user state in such concert than in a football game.

Processor 116 can comprise trigger determination component 132, for determining the existence of a trigger for sending a message to one or more recipients. The trigger may depend on the state of the user as well as on the context. In some embodiments, if the state exceeds a threshold corresponding to a particular context, for example a context for which the state was determined, a trigger for sending a message may be determined. It will be appreciated that the trigger may be pre-defined, for example set to one or more default triggers, manually set by a user, or automatically learned by the system based on past sharing behavior or feedback of the user. For example, if the user sends messages containing clips form concerts he attends, a corresponding trigger may be set automatically.

The information required for determining the context, the state and the trigger may be stored in and retrieved from storage device 112, and may be implemented, for example, in the form of a database. For example, a database may comprise a trigger situation comprised of the user being at a concert of one of his favorite singers, the state being computed in a particular manner, and a trigger is determined of the state exceeds a predetermined threshold.

Processor 116 can comprise template selection component 134 for selecting a message template from a multiplicity of templates stored in storage device 112. The template may be selected to correspond to the context and the user state, and to available materials to be sent in the message. If multiple templates correspond to the context or state, a template having the maximal correspondence ranking may be selected.

Processor 116 can comprise recipient selection component 136, for selecting a recipient or recipient group to whom the message is to be sent. The recipient or recipient group may be determined in accordance with the context and/or the state. For example, if the context is a music concert, then a message may be sent to a first group of the user's friends, while in a sports game the message may be sent to a second group. Further, if the user is somewhat excited in a concert, a message may be sent to only the user's friends who like the singer, but if the user is highly excited, a message may be sent to all his friends. The recipient selection may also be learned from past user behavior, i.e. the messages are sent to the same recipients to whom the user sent in the past

Processor 116 can comprise recipient group forming component 140 for generating the recipient groups for each context or context and state combination. Recipient group forming component 140 can operate by learning from the user's past behavior of sending messages to contacts in certain contexts, and states and for example clustering the contacts, such that contacts that received the same or similar messages in the same or in similar states or groups of states, are clustered together and characteristics thereof are determined. Then, if a future message with the characteristics of a certain cluster, the message will be sent to the recipients in the cluster. It will be appreciated that clustering may be an ongoing process in which the groups are enhanced as more messages are being sent, and optionally upon receiving feedback from the user about messages that were previously sent automatically.

Processor 116 can comprise content material obtaining component 144 for obtaining the relevant materials for the message to be sent, for example images, videos, etc., from storage device 112 and/or from external sources, such as the internet. Obtaining the materials may also include processing some raw materials, for example cropping images, selecting images from a video, adding text to images, or the like.

Processor 116 can comprise message preparation component 148 for preparing the message, including using the materials obtained by content material obtaining component 144. The message may be prepared in accordance with a template stored in storage device 112, in accordance with the context and/or state of the user. If multiple templates correspond to the state and/or context, the template to be used may be selected from the multiplicity of templates.

The message may be sent by any one or more communication components 104.

Referring now to FIG. 2, showing a flowchart of steps in a method for sharing content in accordance with a context.

On step 200, environmental sensory input may be received from one or more environmental sensors, such as sensors 110 embedded within a mobile device 100 associated with the user. The environmental sensory input may be received by sensor data receiving component 120. The environmental sensory input may include data such as location, temperature, or the like, and/or captured content such as images, audio, video, text, or the like.

On step 204, user context may be determined based upon the environmental sensory input, for example by context determination component 124. The context can be determined upon data available from all available sources, which may include scene description as captured by the sensors, personal data, social data, environmental data, proximity to other people, noise intensity, or the like. The context determination may also relate to data collected previously, for example previously downloaded materials.

On step 208, physiological sensory data of the user may be received from physiological sensor 108 by sensor data receiving component 120. The data may include measurements of temperature, pulse, blood pressure, sweat, or others, as well as meta-physiological data such as but not limited to motions, motion amplitude and frequency, motion type or others actions, activities, emotional states, or others.

On step 212, the user state may be determined based upon the physiological sensory data, by state determination component 128. In some embodiments, the state may be determined based also on the context. For example, a different level of excitement may be determined upon the same physiological measurements when received in different contexts.

It will be appreciated that step 200 of receiving environmental sensory input and step 208 of receiving physiological sensory data may be performed simultaneously, and in an ongoing manner and are not limited to a particular order.

On step 216, the existence of a trigger may be determined based upon the context and the state of the user, for example by trigger determination component 132. Trigger determination component 132 may check predetermined conditions related to the state of the user and/or the context. If any of the conditions holds, a trigger may be determined. For example, a trigger may be determined upon a combination of physiological measures exceeding a threshold, wherein in some embodiments, the way the measures are combined, and/or the threshold may be determined in accordance with the context, such that for the same physiological measures, a trigger may or may not be determined, depending on the context. The trigger conditions may also be learned from past user behavior. For instance, the system can learn if a user usually sends a message when in a particular context and/or state. The learned trigger conditions can be improved over time by exploiting feedback from the user or the recipients. Such feedback may include but is not limited to direct feedback, time until messages was read, follow-up conversation, or the like.

On step 218, subject to the determination of a trigger, a template may be selected from a multiplicity of templates stored in storage device 112, for example in accordance with one of the conditions that were found to hold on step 216, and subject to availability of materials required by the template. Selection may be done by sorting the relevant triggers based on a set of metrics, which can include, but is not limited to, number of sensors involved, personalization elements, value to user, bundling index i.e. the capability to be bundled with media content, or the like. It will be appreciated that flexible and dynamic templates can be used. Using templates enables diverse and coherent rendering of the message content, while maintaining the flexibility to create arbitrary messages. The templates can have attached metadata, which describes the type and purpose of the template. The template type can define the data types for a message and media files that can be fused using this template. In some embodiments generic templates can be provided, such as ‘positive emotion’, as well as specific templates such as ‘goal scored’.

On step 220, content materials to be sent to recipients may be determined. The content materials may be determined by content material obtaining component 144, for example based on the template selected on step 218, and associated with the context and/or the user state. The content may include audio, video, images, animation, text or others. The materials may be determined and obtained from storage device 112 or other storage of mobile computing device 100, a remote account, from external sources or the like. The data and may undergo processing such as image processing, audio processing, addition of text or graphics, or the like. The content selection can be automatic, semi-automatic or manual, or can be based on a rule-based system or a learning algorithm. It will be appreciated that steps 218 and 220 are interchangeable, i.e. in some embodiments one may replace the other, while in other embodiments both may be performed, in any required order.

On step 224, a message may be prepared by message preparation component 128, in accordance with the template, based upon the determined and obtained materials. Thus, the message can include any text, animation, audio, video which may also be fused, e.g., text over video, animation over video, audio over audio, etc.).

The message may also include a personal note composed by the user or automatically suggested to the user and optionally approved.

On step 232, one or more recipients or recipient groups may be selected, for example by recipient selection component 136, wherein the recipients or recipient groups are associated with the user, for example are contacts of the user, friends of the user in a social network, or the like. The recipients may be selected from a multiplicity of possible recipients or recipient groups, in accordance with the context and/or the state of the user. In some cases, the message may be sent also, or only, to the user, such that the user can relive or enjoy the experience also at a later time.

On preliminary and/or ongoing step 228, the recipient groups may be formed, for example by recipient group forming component 140 such that any one or more recipients or groups can be selected on step 232.

Recipient group selection component 136 may comprise a multi-class classifier trained to select the recipient group based on the user context and/or state. The selection of the recipient group may also be based on messages previously sent by the user, or messages that have been sent automatically and for which feedback was received from the user or from a recipient.

Recipient group forming component 140 may learn a clustering model that associates the user's contacts with recipient groups. A cluster of contacts may constitute a group which is semantically homogeneous, wherein shared content is sent to the entire group. Some examples for such groups include family members, people that spent time together recently at a particular location or event, coworkers, or the like. The clusters can be learned using frequent item set mining or other clustering methods.

It will be appreciated that the clusters can overlap, such that one contact may be assigned to multiple recipient groups.

Initially, before enough data is available for training, recipient selection can be configured to operate in accordance with a set of default rules. For example, if the user is at work, the message may be sent to colleagues, on weekends the message may be sent to friends or family members, when the user is at an event, the message may be sent to friends with whom the user interacts a lot, or the like. Groups can also be initially formed in accordance with metadata available for contacts in the user's contact list.

The recipient clusters may be updated in an ongoing manner, based on additional sent messages, or feedback received from the user or from other users, whether addressees of messages or not.

On step 236, the message may be sent to the recipients, which may include the user. The message may be sent by communication components 104, in any format, such as e-mail, instant message, a message in a specific application, or the like.

An exemplary scenario provided by the system may be as follows: a user carrying a smart device sets up a trigger condition for automatically messaging his family whenever his team scores in a football game. The trigger condition can be based on a set of predefined or learned rules, including a context characterized by the location being a soccer field and the audio event comprising cheering. The user state may be identified in accordance with the user jumping, and his emotional state being happy or excited. The content of the shared message can take a multitude of forms, from predefined written messages and personalized media, to automatically generated content from the context information itself.

It will be appreciated that determining the context, the state, the trigger, the template, or the materials can be enhanced due to feedback received from the user or from a recipient. The feedback may relate to the message content, design or trigger, the sharing behavior of the sender, or the like.

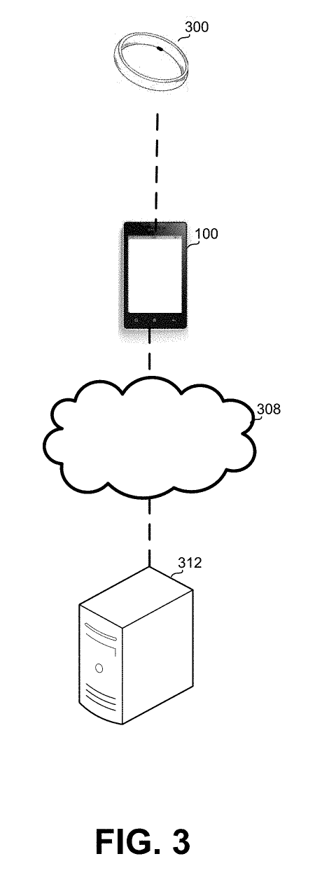

Referring now to FIG. 3, illustrating the main components in another embodiment of a system for sharing content in accordance with a context, in accordance with certain embodiments of the presently disclosed subject matter.

FIG. 3 shows a system comprising, in addition to mobile computing device 100, also another device, such as a wearable device 300, for example a smartwatch, a bracelet, a ring, a head band, or the like. Wearable device 300 can contain one or more sensors such as a physiological sensor designed to feel temperature, motion of the user, or the like. Wearable device 300 may be in communication with mobile computing device 100, for example via Wi-Fi, NFC, Bluetooth, or the like. The sensory information received from wearable device 300 can thus be used similarly, instead of, or in addition to sensory data received from physiological sensor 108.

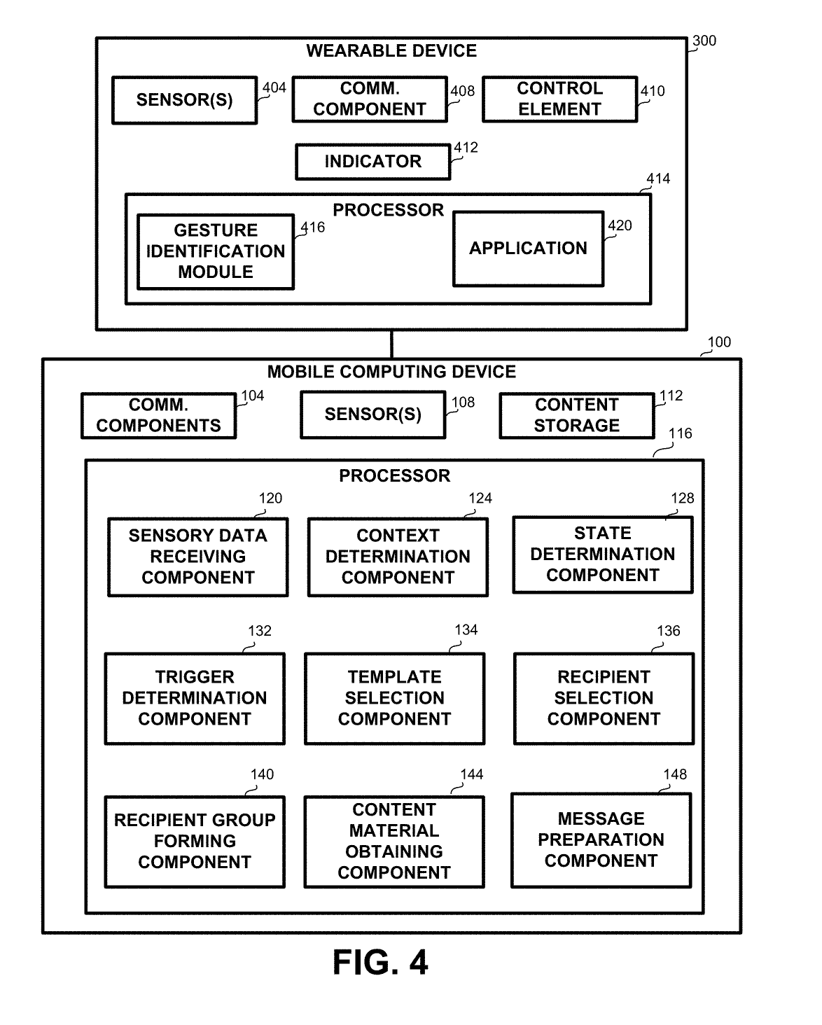

Referring now to FIG. 4, showing a block diagram of an embodiment of the system of FIG. 3, for sharing content in accordance with a context, according to certain embodiments of the presently disclosed subject matter. The system comprises mobile computing device 100, as detailed in association with FIG. 1 above and also wearable device 300, which may be formed as a bracelet, a ring, a glove, a headband, a wrist band or any other wearable device.

Wearable device 300 may include one or more physiological sensors 404, for example a motion sensor, a temperature sensor, or the like.

Wearable device 300 may include a communication component 408 for communicating with mobile computing device 100 through NFC, Wi-Fi. Bluetooth or the like, and/or with other devices, for example via the Internet. Wearable device 300 may also communicate with other devices and is not limited to communicating with mobile computing device 100.

Wearable device 300 may include one or more control elements 410 with which the user can perform actions, for example transmit a measurement to mobile computing device 100.

Wearable device 300 may include one or more indicators 112 for providing a signal to the user or to the environment, for example a visual signal by lighting a LED, an audible signal by playing a sound, a vibration, or the like.

Wearable device 300 may include processor 414 which may be implemented as described in association with processor 116.

Processor 414 can comprise or load and/or execute a gesture identification module 416, for identifying one or more gestures from motions sensed by sensor 404, and application 420 for performing an action with physiological sensory input received from sensor 104, with a gesture identified by gesture identification module 416, with a control action received by control element 410, or the like, for example transmit indications to mobile computing device 100, turn indicator 412 on or off, or the like.

In some examples, a message may be created automatically and may await confirmation by a user, wherein the user may be notified about the waiting message by indicator 412 being turned on. The indicator may be turned off once the message has been sent or discarded by the user. In another example, identified gestures may affect the state of the user and hence the trigger. It will be appreciated that multiple other effects of wearable device 300 and mobile computing device 100 on one another can be implemented.

It will be appreciated that not all disclosed steps or their order are mandatory. Thus, it will further be appreciated that some steps may be omitted, performed at different order, or the like.

It is noted that the teachings of the presently disclosed subject matter are not bound by the method and system described with reference to FIGS. 1-4. Equivalent and/or modified functionality can be consolidated or divided in another manner and can be implemented in any appropriate combination of software, firmware and hardware and executed on a suitable device.

Each component of the system may be a standalone network entity, or integrated, fully or partly, with other network entities. Those skilled in the art will also readily appreciate that data repositories may be embedded or accessed by any of the components and can be consolidated or divided in any manner. Databases can be shared with other systems or be provided by other systems, including third party equipment.

It is also noted that whilst the system of FIG. 2 corresponds to the flowchart of FIG. 3, this is by no means binding, and the steps can be performed by elements other than those described herein.

It is to be understood that the invention is not limited in its application to the details set forth in the description contained herein or illustrated in the drawings. The invention is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the presently disclosed subject matter.

It will also be understood that the system according to the invention may be, at least partly, a suitably programmed computer. Likewise, the invention contemplates a computer program being readable by a computer for executing the method of the invention. The invention further contemplates a machine-readable memory tangibly embodying a program of instructions executable by the machine for executing the method of the invention.

Those skilled in the art will readily appreciate that various modifications and changes can be applied to the embodiments of the invention as hereinbefore described without departing from its scope, defined in and by the appended claims.

1. A computer-implemented method for providing content associated with a user, comprising:
receiving environmental sensory input from at least one sensor embedded within a first device associated with the user, the environmental sensory input indicative of a context of the user;
determining the context of the user from at least the environmental sensory input;
receiving physiological sensory input from at least one physiological sensor embedded within a second device associated with the user, the physiological sensory input indicative of a state of the user;
determining the state of the user from at least the physiological sensory input;
determining a trigger based on at least the context and the state of the user;
subject to the trigger, obtaining content materials based at least on the environmental sensory input, to be provided in association with the trigger;
preparing message content to be sent in a message, using at least the content materials; and
sending the message to at least one recipient over a digital communication channel.

2. The method of claim 1, wherein the second device is the first device.

3. The method of claim 1, wherein the message content is prepared in accordance with a template associated with the context and the environmental sensory input.

4. The method of claim 3, wherein the template is selected from a multiplicity of templates in accordance with correspondence with the context and the state.

5. The method of claim 1, wherein the environmental sensory input comprises audio, video or at least one still image captured by the second device.

6. The method of claim 1, wherein the context is obtained from the environmental sensory input and from additional data.

7. The method of claim 6, wherein at least part of the additional data is selected from the group consisting of: a calendar of the user; social media associated with the user; and a location of the user.

8. The method of claim 1, wherein the content materials comprise output obtained by processing at least a portion of the environmental sensory input.

9. The method of claim 1, wherein the content materials are based also on the physiological sensory input or on the state.

10. The method of claim 1, wherein the content materials comprise data obtained from a source external to the user and the second device, or output of processing thereof.

11. The method of claim 1, further comprising sending the message to the user.

12. The method of claim 1, further comprising selecting at least one recipient group comprising the at least one recipient associated with the user, and wherein the message is sent to the at least one recipient group.

13. The method of claim 12, further comprising clustering possible recipients into recipient groups, including the at least one recipient group.

14. The method of claim 1, wherein the state of the user is determined also in accordance with the context.

15. The method of claim 1, wherein determining the trigger is based on past sharing behaviour of the user.

16. A computer-implemented method for providing content to a recipient associated with a user, comprising:
receiving physiological sensory input from at least one sensor embedded within a first device associated with the user, the physiological sensory input indicative of a state of the user;
determining the state of the user from the physiological sensory input;
receiving environmental sensory input from at least one sensor embedded within a second device associated with the user, the environmental sensory input indicative of a context of the user;
determining the context of the user from at least the environmental sensory input;
determining a trigger based on at least the context and the state of the user;
selecting at least one recipient group comprising at least one recipient associated with the user, based at least on the context; and
subject to the trigger, sending a message to the at least one recipient group over a digital communication channel.

17. The method of claim 16 wherein the recipient group is selected based upon the context and the state of the user.

18. The method of claim 16 further comprising generating a model upon which the at least one recipient group is selected.

19. The method of claim 18 wherein the model is generated by clustering possible recipients.

20. The method of claim 18 wherein the model is generated based at least on sharing behaviour of the user.

21. The method of claim 18 wherein the model is enhanced in accordance with user feedback.

22. A computer program product comprising a computer readable storage medium retaining program instructions, which program instructions when read by a processor, cause the processor to perform a method comprising:
receiving environmental sensory input from at least one sensor embedded within a first device associated with the user, the environmental sensory input indicative of a context of the user;
determining the context of the user from at least the environmental sensory input;
receiving physiological sensory input from at least one physiological sensor embedded within a second device associated with the user, the physiological sensory input indicative of a state of the user;
determining the state of the user from at least the physiological sensory input;
determining a trigger based on at least the context and the state of the user;
subject to the trigger, obtaining content materials based at least on the environmental sensory input, to be provided in association with the trigger;
preparing message content to be sent in a message, using at least the content materials; and
sending the message to at least one recipient over a digital communication channel.
